(19) United States
(12) Patent Application Publication
(10) Pub. No.: US 2020/0027315 A1
(43) Pub. Date: Jan. 23, 2020

(54) SYSTEM, METHOD, AND DECENTRALIZED APPLICATION FOR BLOCKCHAIN-BASED GAMBLING

(71) Applicant: Justin D. Cotton, Atlanta, GA (US)

(72) Inventor: Justin D. Cotton, Atlanta, GA (US)

(21) Appl. No.: 16/514,850

(22) Filed: Jul. 17, 2019

Related U.S. Application Data
(60) Provisional application No. 62/698,945, filed on Jul. 17, 2018.

(51) Int. Cl. G07F 17/32; G06Q 20/36; G06Q 20/38; G06Q 20/08; G06Q 50/18; G06Q 50/34

(52) U.S. Cl. CPC G07F 17/3288; G06Q 20/3678; G06Q 20/389; G07F 17/3244; G06Q 50/188; G06Q 50/34; G06Q 20/08

(57) ABSTRACT

A system, method, and decentralized computer application may provide an efficient, distributed, immutable, and disintermediated infrastructure for offering and accepting wagers on sports, gambling, and public events using smart contracts, digital currency, digital currency wallets, and blockchains. One example method may comprise one or more of deploying a smart contract to a blockchain; displaying the smart contract's offered gambling odds related to real-world events in a front-end environment of a decentralized application; using the decentralized application to call functions of the smart contract to accept the offered gambling odds and to authorize transmissions of digital currency representing wagers; calculating commissions payable to the smart contract; retrieving data related to the subject matter of the wager using APIs and external oracle services; the smart contract determining which wagers were successful; and the smart contract transmitting digital currency to the digital wallets of users with winning wagers.

### TECHNICAL FIELD

This application relates to computer applications to facilitate gambling operations, and more specifically to gambling on games of chance and sports events using decentralized applications in conjunction with smart contracts, digital currency wallets, and blockchains.

### BACKGROUND

Recent activity in state courts, as well as in the Supreme Court of the United States, has led to the striking down of federal legislation that prohibited betting on sports outside of the State of Nevada. This, along with the steadily growing interest in professional and amateur sports, as well as the associated appetite for gambling on sports events, has revealed an expanding and so-far unmet market for more robust computer applications that facilitate gambling, especially sports gambling. Furthermore, the proliferation of applications, including decentralized applications or “dApps,” leveraging the advantages of blockchains, presents the opportunity to process sports bets, gambling odds, and payouts by way of digital currency or “cryptocurrency,” digital currency wallets, and digital or “smart” contracts deployed to blockchains. Doing so would greatly automate the oddsmaking, betting, and payout processes, thanks to the efficient, distributed, immutable, and consensus-based characteristics of blockchains or distributed ledgers, which provide advantages over the existing and inefficient in-person, paper-based, cash-dependent, and, until now, largely illegal, sports gambling infrastructures. The subject of this patent application greatly improves the speed, efficiency, accessibility, and integrity of gambling operations, including those involving sports betting, leveraging the advantages of smart contracts, APIs, oracles, distributed autonomous agents or enterprises, and blockchains.

### SUMMARY

In one embodiment, a user may place, and collect winnings on, a fixed odds wager using one or more smart contracts, decentralized applications, digital cryptocurrency wallets, and blockchains. Fixed odds related to a sports event, electronic or “esports” event, or any other event, such as, e.g., a win, loss, final score, or other outcome, may be determined by a smart contract or decentralized application by any suitable method known in the art, such as, e.g. by using a data carrier in conjunction with an application programming interface or “API” to download fixed odds data from a sports data aggregator, which may be verified by a trustless, distributed consensus based on a proof-of-work model using blockchain miners, a proof-of-stake model using blockchain forgers, or one or more external “oracle” services.

Offers to make wagers based on the fixed odds may be displayed by a decentralized application in a web-based front-end environment, which may be supported by one or more smart contracts serving as a back-end environment. Users may fund wagers using digital currency or cryptocurrency that may be stored in and accessed from digital currency wallets secured by private cryptography keys, and the wager may be transferred to a digital currency wallet or “address” associated with the smart contract. Upon determining the outcome of the event that is the basis of the wager, such as, e.g., by using one or more external “oracle” services to verify sports or gambling event data, such as, e.g., sports statistics, retrieved from an application programming interface, and feed the data into the smart contract, the smart contract may facilitate the transfer of funds from a digital currency wallet or “address” associated with the smart contract to one or more digital currency wallets associated with users that made a winning wager. A digital currency wallet or “address” associated with the smart contract, acting here as a bookmaker, may earn a percentage, commission, or “vigorish” of amounts wagered.

In another embodiment, a user may place, and collect winnings on, an in-play, in-event, or live micro-wager using one or more smart contracts, decentralized applications, digital cryptocurrency wallets, and blockchains. Real-time, dynamic, or variable odds related to a sports micro-event that may occur after the start of the overall sports event, such as, e.g., the next play in a gridiron football drive, baseball at-bat, electronic or “esports” micro-event such as, e.g., the results of a single round of a fighting game, score, foul, play, pitch, shot, inning, period, quarter, map, round, or esports quest, may be determined by a smart contract or decentralized application by any suitable method known in the art, such as, e.g., by using a data carrier in conjunction with an application programming interface or “API” to download dynamic, variable, or live odds, or crowdsourced data from a sports data aggregator, which may be verified by a trustless, distributed consensus based on a proof-of-work model using blockchain miners, a proof-of-stake model using blockchain forgers, or one or more external “oracle” services.

Offers to make micro-wagers based on the real-time, dynamic, variable, or live odds may be displayed by a decentralized application in a web-based front-end environment, which may be supported by a smart contract serving as a back-end environment. Users may fund micro-wagers using digital currency or cryptocurrency that may be stored in and accessed from digital currency wallets secured by private cryptography keys, and the micro-wager may be transferred to a digital currency wallet or “address” associated with the smart contract. Upon determining the outcome of the micro-event that is the basis of the micro-wager, such as, e.g., by using one or more external “oracle” services to verify micro-event data, such as, e.g., sports statistics, retrieved from an application programming interface and feed the data into the smart contract, the smart contract may close betting on that micro-event and may facilitate a microtransaction transfer of funds from a digital currency wallet or “address” associated with the smart contract to one or more digital currency wallets associated with users that made a winning micro-wager. A digital currency wallet or “address” associated with the smart contract may earn a percentage, commission, or “vigorish” of amounts wagered.

In yet another embodiment, a user may place, and collect winnings on, an exchange-based conventional or proposition, also known as “prop,” wager, without the need for a middleman, intermediary, oddsmaker, or sportsbook, using one or more smart contracts, decentralized applications, digital cryptocurrency wallets, and blockchains. Users may offer or “lay” odds on a possible outcome of an event not happening, and other users may accept or “back” odds on a possible outcome of an event happening. All users may have the ability to “lay” or “back” odds of their choosing on the exchange. The event in question may be related to a sports event, as described above, or any other event or “side bet,” such as, e.g., the number of sets played to determine the winner of a tennis match or the final digit of the block hash generated for the next block of data to be mined in a blockchain, whose outcome may be determined by a smart contract or decentralized application by any suitable method known in the art, such as, e.g., by using a data carrier in conjunction with an application programming interface or “API” to download event result data from a sports data aggregator, which may be verified by a trustless, distributed consensus based on a proof-of-work model using blockchain miners, a proof-of-stake model using blockchain forgers, or one or more external “oracle” services.

Offers to make wagers based on “laid” or “backed” odds may be displayed by a decentralized application in a web-based front-end environment, which may be supported by a smart contract serving as the back-end environment, and other users may accept these odds, by “backing” or “laying” the offered odds, respectively, using the same interface. Users “laying” odds may transfer the potential payout, which would be paid to users successfully “backing” the odds, to a digital currency wallet or “address” associated with the smart contract, and users “backing” odds may transfer their wager or “stake,” which would be paid to users successfully “laying” the odds, to a digital currency wallet or “address” associated with the smart contract, which may hold the value in escrow. Both “laying” and “backing” users may fund wagers using digital currency or cryptocurrency that may be stored in and accessed from digital currency wallets secured by private cryptography keys. Upon determining the outcome of the event or micro-event that is the basis of the wagers, such as, e.g., by using one or more external “oracle” services to verify sports or gambling event data, such as, e.g., sports statistics, retrieved from an application programming interface, and feed the data into the smart contract, the smart contract may facilitate the transfer of funds from a digital currency wallet associated with the smart contract to one or more digital currency wallets associated with users that made a winning wager. A digital currency wallet associated with the smart contract may earn a percentage, commission, or “vigorish” of amounts wagered.

In yet another embodiment, a user may place, and collect winnings on, a spread betting wager, using one or more smart contracts, decentralized applications, digital cryptocurrency wallets, and blockchains. Users may make wagers based on “buying” or “selling” a spread, at listed “buy” and “sell” prices, associated with an event, such as, e.g., the combined or relative number of points scored by teams or players in a basketball game, and users' winnings or losses may be determined by whether the “correct number” is above or below the spread, and how far the correct number is from the with “buy” and “sell” prices. The correct number associated with the event, which may be the subject of the wagers, may be determined by a smart contract or decentralized application by any suitable method known in the art, such as, e.g., by using a data carrier in conjunction with an application programming interface or “API” to download event result data from a sports data aggregator, which may be verified by a trustless, distributed consensus based on a proof-of-work model using blockchain miners, a proof-of-stake model using blockchain forgers, or one or more external “oracle” services.

Offers to make wagers based on the spreads, buy prices, and sell prices associated with upcoming events may be displayed by a decentralized application in a web-based front-end environment, which may be supported by a smart contract serving as a back-end environment, and users may place wagers using the same interface. Users may transfer their wagers to a digital currency wallet or “address” associated with the smart contract acting as an escrow account. Both users buying and selling the spread may fund wagers using digital currency or cryptocurrency that may be stored in and accessed from digital currency wallets secured by private cryptography keys. Upon determining the outcome of the event that is the basis of the wagers, such as, e.g., by using an external “oracle” service to verify sports or gambling event data, such as, e.g., sports statistics, retrieved from an application programming interface, and feed the data into the smart contract, the smart contract may facilitate the transfer of funds from a digital currency wallet or “address” associated with the smart contract to one or more digital currency wallets associated with users that made a winning wager, and additional losses may be transferred from the digital currency wallets of users making a losing wager, proportional to the difference between the correct number and the price of the losing “buy” or “sell” wager. A digital currency wallet associated with the smart contract may earn a percentage, commission, or “vigorish” of amounts wagered.

In yet another embodiment, a user may place, and collect winnings on, a pari-mutuel or pool betting wager, using one or more smart contracts, decentralized applications, digital cryptocurrency wallets, and blockchains. Users may make wagers on the results of any contest with a fixed number of contestants or entrants, such as, e.g., a horse race, a sports league's final standings, or a sports league's playoff standings, and users' winnings or losses may be calculated proportional to the amount wagered on each available option, after wagering has ended. Users may also make wagers based on traditional pari-mutuel betting that varies by local custom, such as, e.g., a “place” wager, which wagers on a contestant finishing the contest in the top two or three places; a “show” wager, which wagers on the contestant finishing first, second, or third; an “across the board” wager, which is a combination of a normal wager, a “place” wager, and a “show” wager; an “each way” wager, which is a combination of a normal wager and a “place” wager; an “exacta” wager, which wagers on two selections finishing first and second in the correct order; an “any2” or “duet” wager, which wagers on two selections finishing anywhere in the top three places; and a “trifecta” wager, which wagers on three contestants finishing first, second, and third in the correct order.

The outcome of the event, such as, e.g., the finishing order of a horse race or final standings of teams in a sports league, may be determined by a smart contract or decentralized application by any suitable method known in the art, by using a data carrier in conjunction with an application programming interface or “API” to download event result data from a sports data aggregator, which may be verified by a trustless, distributed consensus based on a proof-of-work model using blockchain miners, a proof-of-stake model using blockchain forgers, or one or more external “oracle” services.

Offers to make wagers based on upcoming events may be displayed by a decentralized application in a web-based front-end environment, which may be supported by a smart contract serving as a back-end environment, and users may place wagers using the same interface. Users may fund wagers using digital currency or cryptocurrency that may be stored in and accessed from digital currency wallets secured by private cryptography keys, and the wager may be transferred to a digital currency wallet or “address” associated with the smart contract. Upon determining the outcome of the event that is the basis of the wagers, such as, e.g., by using one or more external “oracle” services to verify sports or gambling event data, such as, e.g., sports statistics, retrieved from an application programming interface, and feed the data into the smart contract, the smart contract may facilitate the transfer of funds from a digital currency wallet associated with the smart contract to one or more digital currency wallets associated with users that made a winning wager. A digital currency wallet associated with the smart contract may earn a percentage, commission, or “vigorish” of amounts wagered.

In still another embodiment, a user may place, and collect winnings on, daily and full-season fantasy sports wagers, using one or more smart contracts, decentralized applications, digital cryptocurrency wallets, and blockchains. Users may make wagers based on, for example, the combined points of virtual teams they create, or virtual teams created by other users, that are associated with the real-life performance of athletes or other entities, based on calculations or algorithms managed by smart contracts or decentralized applications. For example, the number of passing yards tallied by a gridiron football player in a real football game may translate to a certain number of points for a virtual team, and the user that created that virtual team may collect winnings based on having the virtual team with the highest number of points in a day, season, or other duration of time. Data associated with the event and real-world performances may be determined by a smart contract or decentralized application by any suitable method known in the art, such as, e.g., by using a data carrier in conjunction with an application programming interface or “API” to download event and player performance data from a sports data aggregator, which may be verified by a trustless, distributed consensus based on a proof-of-work model using blockchain miners, a proof-of-stake model using blockchain forgers, or one or more external “oracle” services.

Offers to make wagers based on upcoming events or existing virtual teams, and to create one or more virtual teams, may be displayed by a decentralized application in a web-based front-end environment, which may be supported by a smart contract serving as a back-end environment, and other users may place wagers and create one or more virtual teams using the same interface. Users may fund wagers using digital currency or cryptocurrency that may be stored in and accessed from digital currency wallets secured by private cryptography keys, and the wager may be transferred to a digital currency wallet or “address” associated with the smart contract. Upon determining the outcome of the events and real-world performances that may be the basis of the wagers, the smart contract may facilitate the transfer of funds from a digital currency wallet associated with the smart contract to one or more digital currency wallets associated with users that made a winning wager. A digital currency wallet associated with the smart contract may earn a percentage, commission, or “vigorish” of amounts wagered.

In still another embodiment, a user may place, and collect winnings on, wagers related to blockchain data. Users may make wagers based on, for example, the identity or address of the miner that mines the next block in a blockchain, or the block hash of the next block to be mined in a blockchain. Data associated with the block mining event may be tracked by a smart contract or decentralized application by any suitable method known in the art, such as, e.g., by using a data carrier in conjunction with an application programming interface or “API” to download blockchain data, which may be verified by a trustless, distributed consensus based on a proof-of-work model using blockchain miners, or a proof-of-stake model using blockchain forgers.

Offers to make wagers based on, for example, the identity or address of the miner to mine the next block, or the last digit of the block hash of the next block to be mined in a blockchain, may be displayed by a decentralized application in a web-based front-end environment, which may be supported by a smart contract serving as a back-end environment, and other users may place wagers and create one or more virtual teams using the same interface. Users may fund wagers using digital currency or cryptocurrency that may be stored in and accessed from digital currency wallets secured by private cryptography keys, and the wager may be transferred to a digital currency wallet or “address” associated with the smart contract. Upon determining the blockchain data that may be the basis of the wagers, the smart contract may facilitate the transfer of funds from a digital currency wallet associated with the smart contract to one or more digital currency wallets associated with users that made a winning wager. A digital currency wallet associated with the smart contract may earn a percentage, commission, or “vigorish” of amounts wagered.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates a method of placing, and collecting the winnings from, a fixed odds wager made using one or more smart contracts, decentralized applications, digital currency wallets, and blockchains.

FIG. 2 illustrates a method of placing, and collecting the winnings from, a live or in-event wager made using one or more smart contracts, decentralized applications, digital currency wallets, and blockchains.

FIG. 3 illustrates a method of placing, and collecting the winnings from, exchange, proposition, or “prop” betting using one or more smart contracts, decentralized applications, digital currency wallets, and blockchains.

FIG. 4 illustrates a method of placing, and collecting the winnings from, spread betting using one or more smart contracts, decentralized applications, digital currency wallets, and blockchains.

FIG. 5 illustrates a method of placing, and collecting the winnings from, pari-mutuel or pool betting using one or more smart contracts, decentralized applications, digital currency wallets, and blockchains.

FIG. 6 illustrates a method of placing, and collecting the winnings from, daily or full-season fantasy sports betting using one or more smart contracts, decentralized applications, digital currency wallets, and blockchains.

FIG. 7 illustrates a method of placing, and collecting the winnings from, a wager related to blockchain mining data.

FIG. 8 illustrates a system of offering, accepting, and collecting winnings on wagers related to sports and gambling data, which may be facilitated by one or more smart contracts, digital currency wallets, blockchains, external oracle services, data carriers, and application programming interfaces.

### DETAILED DESCRIPTION

It will be readily understood that the instant components, as generally described and illustrated in the figures herein, may be arranged and designed in a wide variety of different configurations. Thus, the following detailed description of the embodiments of at least one of a system, method, non-transitory computer readable medium, and decentralized computer application as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

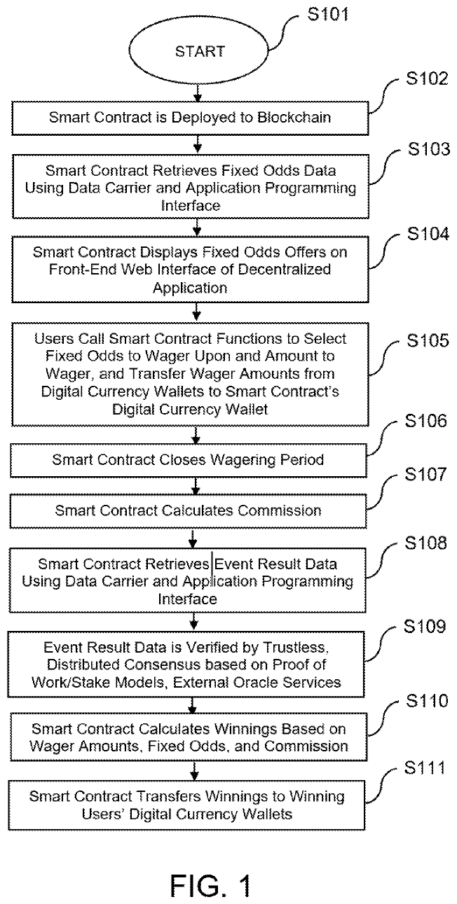

FIG. 1 illustrates a method of placing, and collecting the winnings from, a fixed odds wager made using one or more smart contracts, decentralized applications, digital currency wallets, and blockchains according to example embodiments. In step S101, the method starts. In step S102, one or more initial users 801 may deploy one or more smart contracts 803 to one or more blockchains 804. In step S103, the one or more smart contracts 803 may retrieve fixed odds data by any suitable method known in the art, such as, e.g., using a data carrier and application programming interface (“API”) 814. In another embodiment, the retrieval and verification of the fixed odds data may be facilitated by one or more external “oracle” services 813. In step S104, the one or more smart contracts 803 may display fixed odds offers on a front-end web interface of a decentralized application (“dApp”) 805 in an Internet web browser. In step S105, one or more secondary users 810 may use the front-end web interface of decentralized application (“dApp”) 805 to call functions of the one or more smart contracts 803 to select fixed odds to wager upon and amounts to wager, and to transfer wager amounts from one or more secondary users' digital currency wallets 811 to digital currency wallets associated with the one or more smart contracts 803. In one embodiment, the transfer of digital currency may be authorized using a digital currency wallet available as an Internet browser plugin, such as, e.g., MetaMask. In another embodiment, the one or more secondary users' 810 selection of offered odds and payment for wagers may create a digital acceptance or “handshake” 812 of the initial user's 801 offer and of the one or more smart contract's 803 terms and conditions. In yet another embodiment, the transactions related to the offer of odds, wagers, and acceptance of terms may be recorded on one or more blockchains 804.

In step S106, the one or more smart contracts 803 may cease accepting transfers of digital currency after a predetermined wagering period. In one embodiment, the wagering period may close before the beginning of sports or gambling events, such as, e.g., a gridiron football game, a horse race, a data block mining event, or a round of play of a casino gambling event, that may be the subject of the one or more smart contracts 803. In step S107, the one or more smart contracts 803 may calculate a commission, percentage, or vigorish payable to the one or more smart contracts 803, which may act as the bookmaker or broker of the wagering, based on the amount of wagers placed, and this value may be transferred from initial users' digital currency wallets 802 and secondary users' digital currency wallets 811 to digital currency wallets or addresses associated with the one or more smart contracts 803.

In step S108, the one or more smart contracts 803 may retrieve event result data. In one embodiment, the event result data may be one or more pluralities of sports and gambling data 815, such as, e.g., scores, results, statistics, odds, betting records, injury reports, weather data, voting records, and blockchain transaction data. In another embodiment, events specified in the one or more smart contracts 803 may be monitored by one or more external “oracle” services 813, which may request the data associated with the events from one or more application programming interfaces 814, which may in turn retrieve the plurality of sports and gambling data 815, such as, e.g., real-world sports and gambling statistics and event data, from sources of this data, such as, e.g., Javascript Object Notation (“JSON”) files available from sports, gambling, and event aggregators. The one or more application programming interfaces (“APIs”) 814 may then transmit the plurality of sports and gambling data 815 as responses to requests made by the one or more external “oracle” services 813.

In step S109, the event result data, such as, e.g., a plurality of sports and gambling data 815, may be verified as accurate real-world data. In one embodiment, the event result data may be verified by trustless, distributed consensus based on one or more of proof-of-work or proof-of-stake blockchain models. In another embodiment, the event result data may be verified by one or more external “oracle” services 813. Once the event result data are verified as reflecting real-world occurrences, the plurality of sports and gambling data 815 may be transmitted to the one or more smart contracts 803, which may trigger state changes on one or more blockchains 804 and update information displayed on the front-end of decentralized application (“dApp”) 805.

In step S110, the one or more smart contracts 803 may calculate winnings based on wager amounts, fixed odds, and the previously calculated commission, percentage, or vigorish payable to digital currency wallets or addresses associated with the one or more smart contracts 803 acting as the bookmaker or broker of the wager transactions. In step S111, the one or more smart contracts 803 may transfer winnings, such as, e.g. in values of digital currency or cryptocurrency, such as, e.g., Ether, to secondary users' digital currency wallets 811 associated with secondary users 810, or initial users' digital currency wallets 802 associated with initial users 801, that made winning wagers.

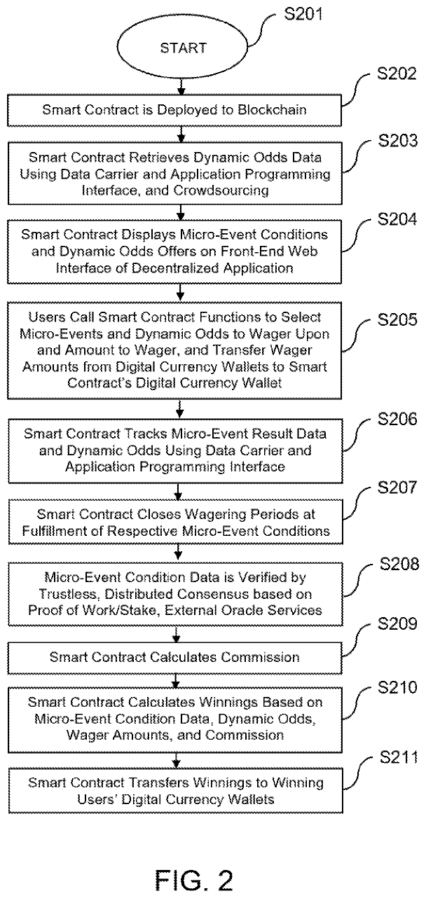

FIG. 2 illustrates a method of placing, and collecting the winnings from, a live or in-event wager made using one or more smart contracts, decentralized applications, digital currency wallets, and blockchains according to example embodiments. In step S201, the method starts. In step S202, one or more initial users 801 may deploy one or more smart contracts 803 to one or more blockchains 804. In step S203, the one or more smart contracts 803 may retrieve dynamic, live, or variable odds data by any suitable method known in the art, such as, e.g., using a data carrier and application programming interface (“API”) 814. In another embodiment, the retrieval and verification of the dynamic, live, or variable odds data may be facilitated by one or more external “oracle” services 813.

In step S204, the one or more smart contracts 803 may display micro-event conditions and dynamic, live, or variable odds offers on a front-end web interface of a decentralized application (“dApp”) 805 in an Internet web browser. In one embodiment, a micro-event may be any suitable portion or division of a full sports or gambling event, such as, e.g., the next play in a gridiron football drive; the next at-bat in a baseball game; the next hand in a poker tournament; a single round of an electronic or “esports” fighting game tournament; score; foul; play; drive; pitch; shot; save; inning; period; quarter; map; round; or esports quest.

In step S205, one or more secondary users 810 may use the front-end web interface of a decentralized application (“dApp”) 805 to call functions of the one or more smart contracts 803 to select micro-events and dynamic, live, or variable odds to wager upon and micro-amounts to wager, and to transfer micro-wager amounts from one or more secondary users' digital currency wallets 811 to digital currency wallets associated with the one or more smart contracts 803. In one embodiment, the transfer of digital currency may be authorized using a digital currency wallet available as an Internet browser plugin, such as, e.g., MetaMask. In another embodiment, the one or more secondary users' 810 selection of offered odds and payment for wagers may create a digital acceptance or “handshake” 812 of the initial user's 801 offer and of the one or more smart contract's 803 terms and conditions. In yet another embodiment, the transactions related to the offer of odds, wagers, and acceptance of terms may be recorded on one or more blockchains 804.

In step S206, the one or more smart contracts 803 may track event result data. In one embodiment, the event result data may be one or more pluralities of sports and gambling data 815, such as, e.g., scores, results, statistics, odds, betting records, injury reports, weather data, voting records, and blockchain transaction data. In another embodiment, events specified in the one or more smart contracts 803 may be monitored by one or more external “oracle” services 813, which may request the data associated with the events from one or more application programming interfaces 814, which may in turn retrieve the plurality of sports and gambling data 815, such as, e.g., real-world sports and gambling statistics and event data, from sources of this data, such as, e.g. Javascript Object Notation (“JSON”) files available from sports, gambling, and event aggregators. The one or more application programming interfaces (“APIs”) 814 may then transmit the plurality of sports and gambling data 815 as responses to requests made by the one or more external “oracle” services 813.

In step S207, the one or more smart contracts 803 may cease accepting transfers of digital currency after a predetermined wagering period. In one embodiment, the wagering period may close at the fulfillment of respective micro-event conditions, such as, e.g., the round, score, foul, play, pitch, shot, inning, period, quarter, map, round, or esports quest, that may be the subject of the one or more smart contracts 803. In step S208, the event result data, such as, e.g., a plurality of sports and gambling data 815, may be verified as accurate real-world data. In one embodiment, the event result data may be verified by trustless, distributed consensus based on one or more of proof-of-work or proof-of-stake blockchain models. In another embodiment, the event result data may be verified by one or more external “oracle” services 813. Once the event result data are verified as reflecting real-world occurrences, the plurality of sports and gambling data 815 may be transmitted to the one or more smart contracts 803, which may trigger state changes on one or more blockchains 804 and update information displayed on the front-end of decentralized application (“dApp”) 805.

In step S209, the one or more smart contracts 803 may calculate a commission, percentage, or vigorish payable to the one or more smart contracts 803, which may act as a bookmaker or broker of the wagering, based on the amount of wagers placed, and this value may be transferred from initial users' digital currency wallets 802 and secondary users' digital currency wallets 811 to digital currency wallets or addresses associated with the one or more smart contracts 803. In step S210, the one or more smart contracts 803 may calculate winnings based on wager amounts; micro-event condition data; dynamic, live, or variable odds; and the previously calculated commission, percentage, or vigorish payable to digital currency wallets or addresses associated with the one or more smart contracts 803 acting as bookmaker or broker of the wager transactions. In step S211, the one or more smart contracts 803 may transfer winnings, such as, e.g. in values of digital currency or cryptocurrency, such as, e.g., Ether, to secondary users' digital currency wallets 811 associated with secondary users 810, or initial users' digital currency wallets 802 associated with initial users 801, that made winning wagers.

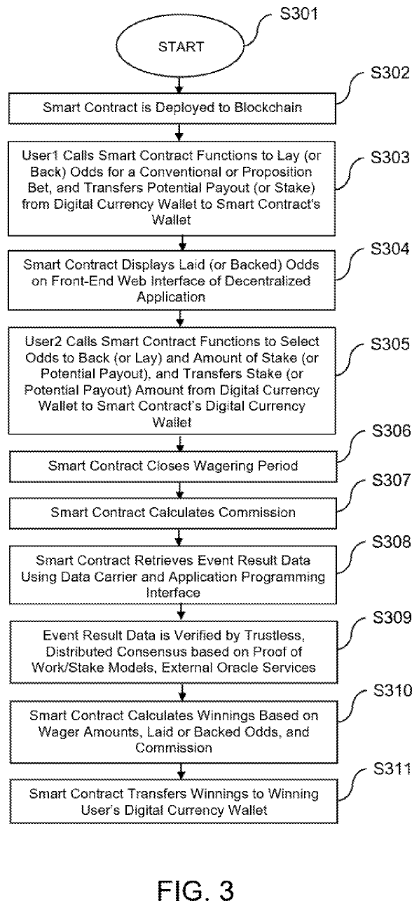

FIG. 3 illustrates a method of placing, and collecting the winnings from, exchange, proposition, or “prop” betting using one or more smart contracts, decentralized applications, digital currency wallets, and blockchains according to example embodiments. In step S301, the method starts. In step S302, one or more initial users 801 may deploy one or more smart contracts 803 to one or more blockchains 804. In step S303, one or more initial users 801 may call functions of the one or more smart contracts 803 to “lay” or “back” odds for conventional or proposition (“prop”) bets. In one embodiment, one or more initial users 801 may “lay” odds that an event, such as, e.g., a sports or gambling outcome, will not occur, and the one or more initial users 801 may transfer an amount of digital currency, which may represent the potential payout if the outcome does occur, from one or more initial users' digital currency wallets 802 to a digital currency wallet associated with the one or more smart contracts 803, which may hold the value in escrow. In another embodiment, one or more initial users 801 may “back” odds that an event, such as, e.g., a sports or gambling outcome, will occur, and the one or more initial users 801 may transfer an amount of digital currency, which may represent the potential stake to be lost if the outcome does not occur, from one or more initial users' digital currency wallets 802 to a digital currency wallet associated with the one or more smart contracts 803, which may hold the value in escrow.

In step S304, the one or more smart contracts 803 may display “laid” or “backed” odds on a front-end web interface of a decentralized application (“dApp”) 805 in an Internet web browser. In step S305, one or more secondary users 810 may use the front-end web interface of a decentralized application (“dApp”) 805 to call functions of the one or more smart contracts 803 to select odds to wager upon, such as, e.g., odds to “lay” or “back,” and amounts to wager, such as, e.g., a potential “payout” or “stake,” and to transfer wager amounts from one or more secondary users' digital currency wallets 811 to digital currency wallets associated with the one or more smart contracts 803. In one embodiment, the transfer of digital currency may be authorized using a digital currency wallet available as an Internet browser plugin, such as, e.g., MetaMask. In yet another embodiment, the one or more secondary users' 810 selection of offered odds and payment for wagers may create a digital acceptance or “handshake” 812 of the initial user's 801 offer and of the one or more smart contract's 803 terms and conditions. In another embodiment, the transactions related to the offer of odds, wagers, and acceptance of terms may be recorded on one or more blockchains 804.

In step S306, the one or more smart contracts 803 may cease accepting transfers of digital currency after a predetermined wagering period. In one embodiment, the wagering period may close before the beginning of sports or gambling events, such as, e.g., a gridiron football game, a horse race, a data block mining event, or a round of play of a casino gambling event, that are the subject of the one or more smart contracts 803. In step S307, the one or more smart contracts 803 may calculate a commission, percentage, or vigorish payable to the one or more smart contracts 803, which may act as a bookmaker or broker of the wagering, based on the amount of wagers placed, and this value may be transferred from initial users' digital currency wallets 802 and secondary users' digital currency wallets 811 to digital currency wallets or addresses associated with the one or more smart contracts 803.

In step S308, the one or more smart contracts 803 may retrieve event result data. In one embodiment, the event result data may be one or more pluralities of sports and gambling data 815, such as, e.g., scores, results, statistics, odds, betting records, injury reports, weather data, voting records, and blockchain transaction data. In another embodiment, events specified in the one or more smart contracts 803 may be monitored by one or more external “oracle” services 813, which may request the data associated with the events from one or more application programming interfaces 814, which may in turn retrieve the plurality of sports and gambling data 815, such as, e.g., real-world sports and gambling statistics and event data, from sources of this data, such as, e.g. Javascript Object Notation (“JSON”) files available from sports, gambling, and event aggregators. The one or more application programming interfaces (“APIs”) 814 may then transmit the plurality of sports and gambling data 815 as responses to requests made by the one or more external “oracle” services 813.

In step S309, the event result data, such as, e.g., a plurality of sports and gambling data 815, may be verified as accurate real-world data. In one embodiment, the event result data may be verified by trustless, distributed consensus based on one or more of proof-of-work or proof-of-stake blockchain models. In another embodiment, the event result data may be verified by one or more external “oracle” services 813. Once the event result data are verified as reflecting real-world occurrences, the plurality of sports and gambling data 815 may be transmitted to the one or more smart contracts 803, which may trigger state changes on one or more blockchains 804 and update information displayed on the front-end of decentralized application (“dApp”) 805.

In step S310, the one or more smart contracts 803 may calculate winnings based on wager amounts, “laid” odds, “backed” odds, and the previously calculated commission, percentage, or vigorish payable to digital currency wallets or addresses associated with the one or more smart contracts 803 acting as a bookmaker or broker of the wager transactions. In step S311, the one or more smart contracts 803 may transfer winnings, such as, e.g. in values of digital currency or cryptocurrency, such as, e.g., Ether, to secondary users' digital currency wallets 811 associated with secondary users 810, or initial users' digital currency wallets 802 associated with initial users 801, that made winning wagers. In one embodiment, the one or more smart contracts 308 may transfer “payouts” to the one or more secondary users' digital currency wallets 811 associated with secondary users 810 that backed odds for an outcome that ultimately occurred. In another embodiment, the one or more smart contracts 308 may transfer “staked” amounts to the one or more initial users' digital currency wallets 802 associated with initial users 801 that laid odds for an outcome that ultimately did not occur.

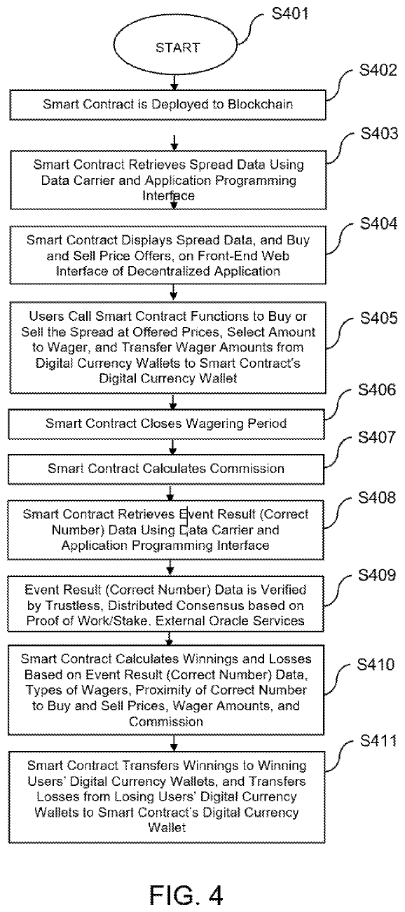

FIG. 4 illustrates a method of placing, and collecting the winnings from, spread betting using one or more smart contracts, decentralized applications, digital currency wallets, and blockchains according to example embodiments. In step S401, the method starts. In step S402, one or more initial users 801 may deploy one or more smart contracts 803 to one or more blockchains 804. In step S403, the one or more smart contracts 803 may retrieve spread data by any suitable method known in the art, such as, e.g., using a data carrier and application programming interface (“API”) 814. In another embodiment, the retrieval and verification of the spread data may be facilitated by one or more external “oracle” services 813.

In step S404, the one or more smart contracts 803 may display spread data, and “buy” and “sell” price offers, on a front-end web interface of a decentralized application (“dApp”) 805 in an Internet web browser. In step S405, one or more secondary users 810 may use the front-end web interface of a decentralized application (“dApp”) 805 to call functions of the one or more smart contracts 803 to select spreads to “buy” or “sell,” and amounts to wager, and to transfer wager amounts from one or more secondary users' digital currency wallets 811 to digital currency wallets associated with the one or more smart contracts 803. In one embodiment, the transfer of digital currency may be authorized using a digital currency wallet available as an Internet browser plugin, such as, e.g., MetaMask. In another embodiment, the one or more secondary users' 810 selection of offered spreads, prices to “buy” or “sell” spreads, and payment for wagers may create a digital acceptance or “handshake” 812 of the initial user's 801 offer and of the one or more smart contract's 803 terms and conditions. In another embodiment, the transactions related to the offer of odds, wagers, and acceptance of terms may be recorded on one or more blockchains 804.

In step S406, the one or more smart contracts 803 may cease accepting transfers of digital currency after a predetermined wagering period. In one embodiment, the wagering period may close before the beginning of sports or gambling events, such as, e.g., a gridiron football game, a horse race, a data block mining event, or a round of play of a casino gambling event, that are the subject of the one or more smart contracts 803. In step S407, the one or more smart contracts 803 may calculate a commission, percentage, or vigorish payable to the one or more smart contracts 803, which may act as a bookmaker or broker of the wagering, based on the amount of wagers placed, and this value may be transferred from initial users' digital currency wallets 802 and secondary users' digital currency wallets 811 to digital currency wallets or addresses associated with the one or more smart contracts 803.

In step S408, the one or more smart contracts 803 may retrieve event result data, such as, e.g., the “correct number” of a statistic, such as, e.g., the actual difference in points scored by two teams in a game. In one embodiment, the event result data may be one or more pluralities of sports and gambling data 815, such as, e.g., scores, results, statistics, odds, betting records, injury reports, weather data, voting records, and blockchain transaction data. In another embodiment, events specified in the one or more smart contracts 803 may be monitored by one or more external “oracle” services 813, which may request the data associated with the events from one or more application programming interfaces 814, which may in turn retrieve the plurality of sports and gambling data 815, such as, e.g., real-world sports and gambling statistics and event data, from sources of this data, such as, e.g. Javascript Object Notation (“JSON”) files available from sports, gambling, and event aggregators. The one or more application programming interfaces (“APIs”) 814 may then transmit the plurality of sports and gambling data 815 as responses to requests made by the one or more external “oracle” services 813.

In step S409, the event result data, such as, e.g., a plurality of sports and gambling data 815, such as, e.g. the correct number of a statistic, such as, e.g., the actual difference in points scored by two teams in a game, may be verified as accurate real-world data. In one embodiment, the event result data may be verified by trustless, distributed consensus based on one or more of proof-of-work or proof-of-stake blockchain models. In another embodiment, the event result data may be verified by one or more external “oracle” services 813. Once the event result data are verified as reflecting real-world occurrences, the plurality of sports and gambling data 815 may be transmitted to the one or more smart contracts 803, which may trigger state changes on one or more blockchains 804 and update information displayed on the front-end of decentralized application (“dApp”) 805.

In step S410, the one or more smart contracts 803 may calculate winnings based on wager amounts; types of wagers; spread data; the “correct number” of a statistic, such as, e.g., the actual difference in points scored by two teams in a game; the proximity of the “correct number” to “buy” and “sell” prices, and the previously calculated commission, percentage, or vigorish payable to digital currency wallets or addresses associated with the one or more smart contracts 803 acting as a bookmaker or broker of the wager transactions. In step S411, the one or more smart contracts 803 may transfer winnings, such as, e.g. in values of digital currency or cryptocurrency, such as, e.g., Ether, to secondary users' digital currency wallets 811 associated with secondary users 810, or initial users' digital currency wallets 802 associated with initial users 801, that made winning wagers. In one embodiment, the one or more smart contracts 308 may transfer value in cryptocurrency to the one or more secondary users' digital currency wallets 811 associated with secondary users 810 that “bought” a spread that was “covered,” or “sold” a spread that was not “covered.”

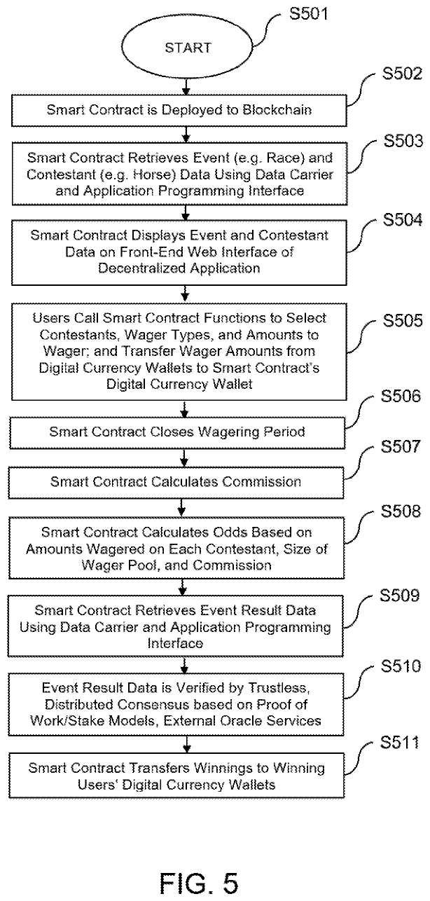

FIG. 5 illustrates a method of placing, and collecting the winnings from, pari-mutuel or pool betting using one or more smart contracts, decentralized applications, digital currency wallets, and blockchains according to example embodiments. In step S501, the method starts. In step S502, one or more initial users 801 may deploy one or more smart contracts 803 to one or more blockchains 804. In step S503, the one or more smart contracts 803 may retrieve event and contestant data by any suitable method known in the art, such as, e.g., using a data carrier and application programming interface (“API”) 814. In another embodiment, the retrieval and verification of the spread data may be facilitated by one or more external “oracle” services 813. In one embodiment, the data may be related to any suitable event with a finite number of contestants, such as, e.g., a horse race, sports league playoff season, gambling competition, or public election.

In step S504, the one or more smart contracts 803 may display event and contestant data, and wager types, on a front-end web interface of a decentralized application (“dApp”) 805 in an Internet web browser. In step S505, one or more secondary users 810 may use the front-end web interface of a decentralized application (“dApp”) 805 to call functions of the one or more smart contracts 803 to select events, contestants, wager types, and amounts to wager, and to transfer wager amounts from one or more secondary users' digital currency wallets 811 to digital currency wallets associated with the one or more smart contracts 803.

In one embodiment, the wager types may be based on traditional pari-mutuel betting that varies by local custom, such as, e.g., a “place” wager, which wagers on a contestant finishing the contest in the top two or three places; a “show” wager, which wagers on the contestant finishing first, second, or third; an “across the board” wager, which is a combination of a normal wager, a “place” wager, and a “show” wager; an “each way” wager, which is a combination of a normal wager and a “place” wager; an “exacta” wager, which wagers on two selections finishing first and second in the correct order; an “any2” or “duet” wager, which wagers on two selections finishing anywhere in the top three places; and a “trifecta” wager, which wagers on three contestants finishing first, second, and third in the correct order.

In another embodiment, the transfer of digital currency may be authorized using a digital currency wallet available as an Internet browser plugin, such as, e.g., MetaMask. In yet another embodiment, the one or more secondary users' 810 selection of contestants to wager upon, wager types, and payment for wagers may create a digital acceptance or “handshake” 812 of the initial user's 801 offer and of the one or more smart contract's 803 terms and conditions. In another embodiment, the transactions related to the offer of odds, wagers, and acceptance of terms may be recorded on one or more blockchains 804.

In step S506, the one or more smart contracts 803 may cease accepting transfers of digital currency after a predetermined wagering period. In one embodiment, the wagering period may close before the beginning of sports or gambling events, such as, e.g., the beginning of a sports league season or postseason, a horse race, or a public election, that may be the subject of the one or more smart contracts 803. In step S507, the one or more smart contracts 803 may calculate a commission, percentage, or vigorish payable to the one or more smart contracts 803, which may act as a bookmaker or broker of the wagering, based on the amount of wagers placed, and this value may be transferred from initial users' digital currency wallets 802 and secondary users' digital currency wallets 811 to digital currency wallets or addresses associated with the one or more smart contracts 803. In step S508, the one or more smart contracts 803 may calculate odds based on amounts wagered on each contestant; size of the wager pool; and the previously calculated commission, percentage, or vigorish payable to digital currency wallets or addresses associated with the one or more smart contracts 803 acting as a bookmaker or broker of the wager transactions.

In step S509, the one or more smart contracts 803 may retrieve event result data, such as, e.g., the finishing order of horses in a race, the final standings of teams in a sports league, or the finishing order of candidates in a public election. In one embodiment, the event result data may be one or more pluralities of sports and gambling data 815, such as, e.g., scores, results, statistics, odds, betting records, injury reports, weather data, voting records, and blockchain transaction data. In another embodiment, events specified in the one or more smart contracts 803 may be monitored by one or more external “oracle” services 813, which may request the data associated with the events from one or more application programming interfaces 814, which may in turn retrieve the plurality of sports and gambling data 815, such as, e.g., real-world sports and gambling statistics and event data, from sources of this data, such as, e.g. Javascript Object Notation (“JSON”) files available from sports, gambling, and event aggregators. The one or more application programming interfaces (“APIs”) 814 may then transmit the plurality of sports and gambling data 815 as responses to requests made by the one or more external “oracle” services 813.

In step S510, the event result data, such as, e.g., a plurality of sports and gambling data 815, such as, e.g. the finishing order of horses in a race, the final standings of teams in a sports league, or the finishing order of candidates in a public election, may be verified as accurate real-world data. In one embodiment, the event result data may be verified by trustless, distributed consensus based on one or more of proof-of-work or proof-of-stake blockchain models. In another embodiment, the event result data may be verified by one or more external “oracle” services 813. Once the event result data are verified as reflecting real-world occurrences, the plurality of sports and gambling data 815 may be transmitted to the one or more smart contracts 803, which may trigger state changes on one or more blockchains 804 and update information displayed on the front-end of decentralized application (“dApp”) 805.

In step S511, the one or more smart contracts 803 may calculate winnings based on wager amounts; types of wagers; the performance of the contestants in the event, such as, e.g., the finishing order of horses in a race, the final standings of teams in a sports league, or the finishing order of candidates in a public election; and the previously calculated commission, percentage, or vigorish payable to digital currency wallets or addresses associated with the one or more smart contracts 803 acting as a bookmaker or broker of the wager transactions. The one or more smart contracts 803 may then transfer winnings, such as, e.g. in values of digital currency or cryptocurrency, such as, e.g., Ether, to secondary users' digital currency wallets 811 associated with secondary users 810 that made winning wagers. In one embodiment, the total betting pool, minus the commission, percentage, or vigorish payable to digital currency wallets or addresses associated with the one or more smart contracts 803 acting as a bookmaker or broker of the wager transactions, may be distributed by the one or more smart contracts 308 between the one or more secondary users' digital currency wallets 811 associated with secondary users 810 that made successful wagers.

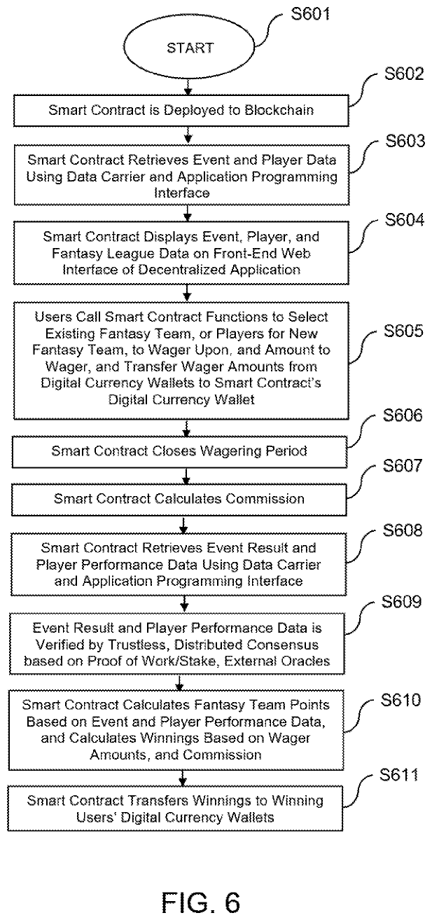

FIG. 6 illustrates a method of placing, and collecting the winnings from, daily or full-season fantasy sports betting using one or more smart contracts, decentralized applications, digital currency wallets, and blockchains according to example embodiments. In step S601, the method starts. In step S602, one or more initial users 801 may deploy one or more smart contracts 803 to one or more blockchains 804. In step S603, the one or more smart contracts 803 may retrieve event, player, and fantasy league data by any suitable method known in the art, such as, e.g., using a data carrier and application programming interface (“API”) 814. In another embodiment, the retrieval and verification of the event, player, and fantasy league data may be facilitated by one or more external “oracle” services 813.

In step S604, the one or more smart contracts 803 may display event, player, and fantasy league data on a front-end web interface of a decentralized application (“dApp”) 805 in an Internet web browser. In step S605, one or more secondary users 810 may use the front-end web interface of a decentralized application (“dApp”) 805 to call functions of the one or more smart contracts 803 to select an existing fantasy team, or players for a new fantasy team, to place a wager on, and amounts to wager, and to transfer wager amounts from one or more secondary users' digital currency wallets 811 to digital currency wallets associated with the one or more smart contracts 803.

In one embodiment, the transfer of digital currency may be authorized using a digital currency wallet available as an Internet browser plugin, such as, e.g., MetaMask. In another embodiment, the one or more secondary users' 810 selection of an existing fantasy team or players for a new fantasy team, and payment for wagers may create a digital acceptance or “handshake” 812 of the initial user's 801 offer and of the one or more smart contract's 803 terms and conditions. In another embodiment, the transactions related to the offer of odds, wagers, and acceptance of terms may be recorded on one or more blockchains 804.

In step S606, the one or more smart contracts 803 may cease accepting transfers of digital currency after a predetermined wagering period. In one embodiment, the wagering period may close before the beginning of sports or gambling events, such as, e.g., a gridiron football game, that are the subject of the one or more smart contracts 803. In step S607, the one or more smart contracts 803 may calculate a commission, percentage, or vigorish payable to the one or more smart contracts 803, which may act as the broker of the wagering, based on the amount of wagers placed, and this value may be transferred from initial users' digital currency wallets 802 and secondary users' digital currency wallets 811 to digital currency wallets or addresses associated with the one or more smart contracts 803.

In step S608, the one or more smart contracts 803 may retrieve event result data, such as, e.g., sports statistics representing the real-world performance of players and teams in a sports league. In one embodiment, the event result data may be one or more pluralities of sports and gambling data 815, such as, e.g., scores, results, statistics, player news, team news, league news, and injury reports. In another embodiment, events specified in the one or more smart contracts 803 may be monitored by one or more external “oracle” services 813, which may request the data associated with the events from one or more application programming interfaces 814, which may in turn retrieve the plurality of sports and gambling data 815, such as, e.g., real world sports and gambling statistics and event data, from sources of this data, such as, e.g. Javascript Object Notation (“JSON”) files available from sports, gambling, and event aggregators. The one or more application programming interfaces (“APIs”) 814 may then transmit the plurality of sports and gambling data 815 as responses to requests made by the one or more external “oracle” services 813.

In step S609, the event result data, such as, e.g., a plurality of sports and gambling data 815, such as, e.g. sports statistics representing the real-world performance of players and teams in a sports league, may be verified as accurate real-world data. In one embodiment, the event result data may be verified by trustless, distributed consensus based on one or more of proof-of-work or proof-of-stake blockchain models. In another embodiment, the event result data may be verified by one or more external “oracle” services 813. Once the event result data are verified as reflecting real-world occurrences, the plurality of sports and gambling data 815 may be transmitted to the one or more smart contracts 803, which may trigger state changes on one or more blockchains 804 and update information displayed on the front-end of decentralized application (“dApp”) 805.

In step S610, the one or more smart contracts 803 may calculate fantasy team points based on event and player performance data, such as, e.g., sports statistics representing the real-world performance of players and teams in a sports league, and calculate winnings based on wager amounts; types of wagers; and the previously calculated commission, percentage, or vigorish payable to digital currency wallets or addresses associated with the one or more smart contracts 803 acting as the broker of the wager transactions. In step S611, the one or more smart contracts 803 may transfer winnings, such as, e.g. in values of digital currency or cryptocurrency, such as, e.g., Ether, to secondary users' digital currency wallets 811 associated with secondary users 810 whose teams earned the most fantasy points, relative to one or more other fantasy teams, during a predetermined period of time.

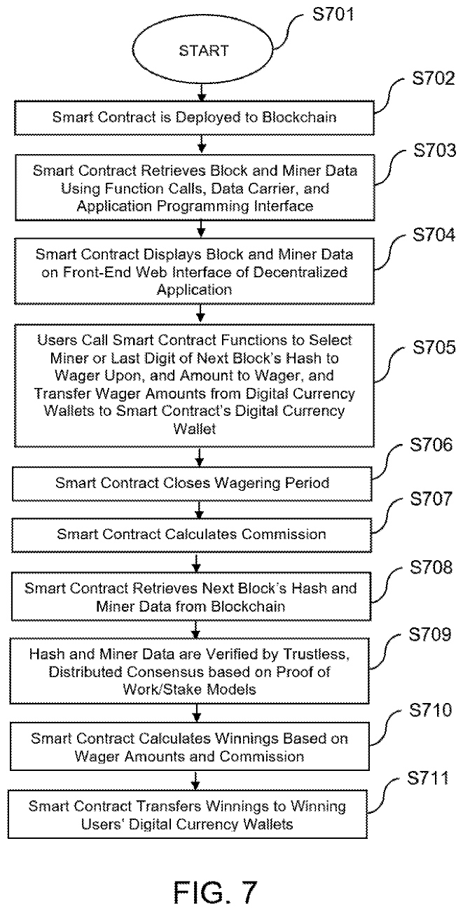

FIG. 7 illustrates a method of placing, and collecting the winnings from, a wager related to blockchain mining data according to example embodiments. In step S701, the method starts. In step S702, one or more initial users 801 may deploy one or more smart contracts 803 to one or more blockchains 804. In step S703, the one or more smart contracts 803 may retrieve blockchain data by any suitable method known in the art, such as, e.g., using a data carrier and application programming interface (“API”) 814. In step S704, the one or more smart contracts 803 may display block and miner data on a front-end web interface of a decentralized application (“dApp”) 805 in an Internet web browser.

In step S705, one or more secondary users 810 may use the front-end web interface of a decentralized application (“dApp”) 805 to call functions of the one or more smart contracts 803 to select a miner, or a last digit of the next block hash, to place a wager on, and amounts to wager, and to transfer wager amounts from one or more secondary users' digital currency wallets 811 to digital currency wallets associated with the one or more smart contracts 803.

In one embodiment, the transfer of digital currency may be authorized using a digital currency wallet available as an Internet browser plugin, such as, e.g., MetaMask. In another embodiment, the one or more secondary users' 810 selection of a miner or a last digit of the next block's hash, and payment for wagers, may create a digital acceptance or “handshake” 812 of the initial user's 801 offer and of the one or more smart contract's 803 terms and conditions. In another embodiment, the transactions related to the offer of odds, wagers, and acceptance of terms may be recorded on one or more blockchains 804.

In step S706, the one or more smart contracts 803 may cease accepting transfers of digital currency after a predetermined wagering period. In one embodiment, the wagering period may close before the mining of the block that is the subject of the one or more smart contracts 803. In step S707, the one or more smart contracts 803 may calculate a commission, percentage, or vigorish payable to the one or more smart contracts 803, which may act as a bookmaker or broker of the wagering, based on the amount of wagers placed, and this value may be transferred from initial users' digital currency wallets 802 and secondary users' digital currency wallets 811 to digital currency wallets or addresses associated with the one or more smart contracts 803.

In step S708, the one or more smart contracts 803 may retrieve block data, such as, e.g., data related to the next mined block, such as, e.g., the address of the miner that mined the block, and the hash of the block. In step S709, the block data, such as, e.g., the address of the miner than mined the block and the block hash of the block, may be verified. In one embodiment, the event result data may be verified by trustless, distributed consensus based on one or more of proof-of-work or proof-of-stake blockchain models, and the block data may be displayed on the front-end of decentralized application (“dApp”) 805.

In step S710, the one or more smart contracts 803 may calculate winnings based on wager amounts; types of wagers; and the previously calculated commission, percentage, or vigorish payable to digital currency wallets or addresses associated with the one or more smart contracts 803 acting as a bookmaker or broker of the wager transactions. In step S611, the one or more smart contracts 803 may transfer winnings, such as, e.g. in values of digital currency or cryptocurrency, such as, e.g., Ether, to secondary users' digital currency wallets 811 associated with secondary users 810 that made successful wagers.

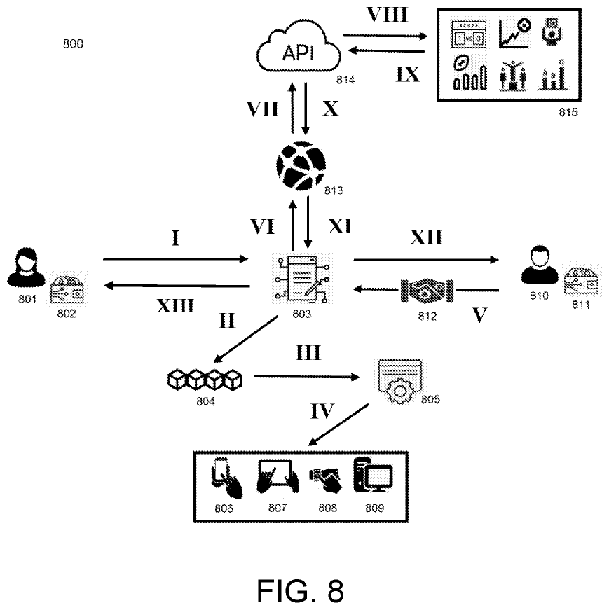

FIG. 8 illustrates a system of offering, accepting, and collecting winnings on wagers related to sports and gambling data, which may be facilitated by one or more smart contracts, digital currency wallets, blockchains, external oracle services, data carriers, and application programming interfaces according to example embodiments. A system 800 that may be used to offer, accept, and facilitate payments related to sports and gaming wagers may include one more initial users 801, one or more initial users' digital currency wallets 802, one or more digital or “smart” contracts 803, one or more blockchains 804, one or more decentralized applications (“dApps”) 805, one or more mobile computers or “smartphones” 806, one or more tablet computers 807, one or more wearable computers 808, one or more desktop computers 809, one or more secondary users 810, one or more secondary users' digital currency wallets 811, one or more digital agreement events or “handshakes” 812, one or more external oracle services 813, one or more application programming interfaces 814, and one or more pluralities of sports and gambling data 815.

Initial user 801 and secondary user 810 may be any suitable entity known in the art, such as, e.g., one or more individual humans, organizations of humans, organizations of organizations, smart contracts, artificial intelligences, autonomous agents, distributed autonomous agents, or decentralized autonomous organizations. Initial users' digital currency wallets 802 and secondary users' digital currency wallets 811 may be any suitable digital wallet known in the art, such as, e.g., an electronic device or online service that facilitates the storage, transmission, and reception of currency, including digital or cryptocurrency. Smart contract 803 may be any suitable computer protocol known in the art adapted to digitally facilitate, verify, enforce, or disintermediate the negotiation or performance of a contract, such as, e.g., computer code written in the Javascript or Solidity object-oriented computer programming languages to define and monitor terms, conditions, and events related to legal or financial transactions in connection with a blockchain.

Blockchain 804 may be any suitable distributed ledger adapted to store transaction data on an open, decentralized, disintermediated, and trustless network of computer nodes, such as, e.g., the Ethereum blockchain. Decentralized application (“dApp”) 805 may be any suitable computer application known in the art, such as, e.g., an application deployed to a blockchain, with a front-end accessible using an Internet browser and its back-end computer code, such as, e.g., a smart contract, running on a decentralized peer-to-peer computer network, and with an unbounded number of participants. Mobile computer 806 and tablet computer 807 may be any suitable portable computer devices known in the art, such as, e.g. smartphones or tablets, respectively. Wearable computer 808 may be any suitable device known in the art, such as, e.g., a smart watch or wearable optical computing apparatus.

Digital agreement event or “handshake” 812 may be any suitable means of accepting the terms of a smart contract known in the art, such as, e.g., using an Internet browser-enabled utility, such as, e.g., MetaMask, to authorize a digital currency transaction to, for example, place a wager or transfer cryptocurrency to another digital currency address in response to an offered wager, odds, price, or other value proposition. External oracle service 813 may be any suitable external computer, or network of external computers or oracles, configured to request, send, and verify real-world occurrences and submit the data provided as a response to smart contracts 803, which may trigger state changes on blockchain 804. Application programming interface (“API”) 814 may be any suitable definitions, protocols, tools, or computer code configured to facilitate the creation of software, such as, e.g., software adapted to retrieve data from databases, applications, or other APIs. Plurality of sports and gambling data 815 may be any suitable form of data related to sports or gambling, such as, e.g., scores, results, statistics, odds, betting records, injury reports, weather data, voting records, and blockchain transaction data.

In section of I of FIG. 8, initial user 801 may write or code a smart contract 803, which may specify the terms of one or more offered wagers, including an offered wager amount, betting odds, and sports or gambling events upon which the wager may be based. The terms and events of the wager may be expressed in a computer language such as, e.g., Solidity. In section II, initial user 801 may expend digital value, such as, e.g., Ether or “gas,” to deploy smart contract 803 to blockchain 804, such as, e.g., the Ethereum blockchain. Once deployed, smart contract 803, may have its own digital currency wallet or address, which may be used later to store wagers and winnings in escrow until payouts are determined and transferred.

In section III, smart contract 803, now deployed to blockchain 804, may serve as the backend of a decentralized application (“dApp”) 805 whose front-end may be accessible in a web browser. One or more secondary users 810 may interact with decentralized application (“dApp”) 805 to view the offered terms of smart contract 803 on one or more of a mobile computer or smartphone 806, tablet computer 807, wearable computer 808, or desktop computer 809. In section V, one or more secondary users 810 may interact with decentralized application (“dApp”) 805 to perform digital agreement events or “handshakes” 812 accepting the offered terms of smart contract 803. In one embodiment, one or more secondary users 810 may authorize a transfer of digital currency from associated secondary users' digital currency wallets 811 to smart contract 803, using, for example, an Internet browser-enabled utility such as, e.g., MetaMask to place a wager, and there may be associated transaction costs, such as, e.g., in values of Ether or “gas.” After a predetermined period of time, smart contract 803 may no longer accept digital agreement events or “handshakes” 812 on certain offered terms.

In section VI, events specified in smart contract 803 may be monitored by one or more external “oracle” services 813, and in section VII, one or more external “oracle” services 813 may request the data associated with the events from one or more application programming interfaces 814. In section VIII, one or more application programming interfaces 814 may retrieve a plurality of sports and gambling data 815, such as, e.g., real-world sports and gambling statistics and event data, from sources of this data, such as, e.g. Javascript Object Notation (“JSON”) files available from sports, gambling, and event aggregators, and in section IX, plurality of sports and gambling data 815 may be transmitted back to the one or more application programming interfaces 814. In section X, plurality of sports and gambling data 815 may then be transmitted to one or more external “oracle” services 813 in response to requests sent by one or more external “oracle” services 813, and in section XI, one or more external “oracle” services 813 may verify and send plurality of sports and gambling data 815 related to real-world occurrences to smart contract 803, which may trigger state changes on blockchain 804 and update information displayed on the front-end of decentralized application (“dApp”) 805. In section XII, smart contract 803 may transfer digital currency to one or more secondary users' digital currency wallets 811 associated with one or more secondary users 810 whose wagers were successful, based on plurality of sports and gambling data 815. In section XIII, smart contract 803 may transfer digital currency to one or more initial users' digital currency wallets 802 associated with one or more initial users 801 whose wagers were successful, based on plurality of sports and gambling data 815.

Although an exemplary embodiment of at least one of a system, method, non-transitory computer readable medium, and decentralized computer application has been illustrated in the accompanied drawings and described in the foregoing detailed description, it will be understood that the subject of the patent application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both.

For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a mobile phone, a tablet computing device, a smartphone, or any other suitable computing device, or combination of devices. Presenting the above-described functions as being performed by a “system” is not intended to limit the scope of the present application in any way but instead is intended to provide one example of many embodiments. Indeed, methods, systems and apparati disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom, very large-scale integration (VLSI) circuits or gate arrays, off-the-shelf semiconductors such as, e.g., logic chips, transistors, or other discrete components. A module may also be implemented in programmable hardware devices such as, e.g., field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may also comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
one or more initial users deploying one or more smart contract computer protocols to one or more blockchains, the one or more smart contract computer protocols being adapted to digitally facilitate, verify, and enforce the negotiation and performance of a contractual relationship, and serve as back-end environments for one or more decentralized applications;
displaying one or more offered terms of the one or more smart contract computer protocols in a front-end environment of the one or more decentralized applications;
one or more secondary users using the front-end environment of the one or more decentralized applications to execute one or more functions of the one or more smart contract computer protocols to accept one or more of the offered terms of the one or more smart contract computer protocols;
the one or more secondary users using the front-end environment of the one or more decentralized applications to authorize one or more transmissions of digital currency to one or more digital currency wallets associated with the one or more smart contract computer protocols according to the accepted terms;
the one or more smart contract computer protocols terminating the ability of additional secondary users to accept offered terms after a predetermined time;
the one or more smart contract computer protocols calculating a commission payable by the one or more secondary users to one or more digital currency wallets associated with the one or more smart contract computer protocols;
the one or more smart contract computer protocols retrieving data related to the offered and accepted terms of the one or more smart contract computer protocols;
the one or more smart contract computer protocols determining values of digital currency owed to initial and secondary users based on the offered and accepted terms, retrieved data, and amounts of the previously authorized transmissions of digital currency; and
the one or more smart contract computer protocols transmitting values of digital currency to digital currency wallets associated with initial and secondary users to which the values are owed.

2. The method of claim 1, wherein the offered terms are one of fixed odds, dynamic odds, live odds, in-event odds, odds that an event will happen, odds that an event will not happen, prices to buy odds that an event statistic will be true, prices to sell odds that an event statistic will be false, odds related to the finishing order of contestants in a contest, points related to the real-world performance of persons or groups of persons, odds related to the identity of a party to mine a particular block in a blockchain, and odds related to characteristics of a particular block in a blockchain.

3. The method of claim 1, wherein the acceptance of the one or more of the offered terms, and authorization of the one or more transmissions of digital currency, comprise a wager on the subject matter of the one or more smart contract computer protocols.

4. The method of claim 2, wherein the event is one or more of a sports event, a gambling event, a public contest, and a divisible micro-event thereof.

5. The method of claim 1, further comprising the data being retrieved, verified as accurate real-world data, and transmitted to the one or more smart contract computer protocols by one or more of one or more application programming interfaces, one or more data carriers, one or more proof-of-stake blockchain models, one or more proof-of-work blockchain models, one or more data aggregators, and one or more external oracle services.

6. The method of claim 1, wherein the data is one or more of fixed odds, dynamic odds, micro-event data, scores, statistics, point spreads, news, event outcome data, blockchain data, gambling data, and records.

7. A system, comprising:
one or more smart contract computer protocols adapted to be deployed to one or more blockchains; digitally facilitate, verify, and enforce the negotiation and performance of a contractual relationship; and serve as back-end environments for one or more decentralized applications;
one or more decentralized applications adapted to enable one or more users to interact with the one or more smart contract computer protocols;
one or more digital currency wallets adapted to store, transmit, and receive digital currency;
one or more blockchains;
one or more computing devices adapted to display the one or more decentralized applications;
one or more external oracle services adapted to request, verify, and submit data related to real-world occurrences;
one or more application programming interfaces adapted to retrieve and transmit data;
one or more data carriers adapted to store and transmit non-transitory machine-readable data;
one or more data aggregators adapted to collect, store, and transmit data;
one or more means of digitally accepting terms offered by the one or more smart contract computer protocols, and authorizing the transmission of digital currency to digital currency wallets and smart contract computer protocols; and
one or more pluralities of data, wherein the pluralities of data are related to one or more of sports events, gambling events, blockchain mining events, public events, and divisible micro-events thereof.

8. The system of claim 7, wherein the contractual relationship is a wager between one or more of one or more individual humans, organizations of humans, organizations of organizations, smart contracts, artificial intelligences, distributed autonomous agents, and decentralized autonomous organizations.

9. A non-transitory computer-readable storage medium configured to store instructions that when executed causes a processor to perform:
deploying one or more smart contract computer protocols, provided by one or more users, to one or more blockchains, the one or more smart contract computer protocols being adapted to digitally facilitate, verify, and enforce the negotiation and performance of a contractual relationship, and serve as back-end environments for one or more decentralized applications;
displaying one or more offered terms of the one or more smart contract computer protocols in a front-end environment of the one or more decentralized applications;
executing one or more functions of the one or more smart contract computer protocols to accept one or more of the offered terms of the one or more smart contract computer protocols;
authorizing one or more transmissions of digital currency to one or more digital currency wallets associated with the one or more smart contract computer protocols according to the accepted terms;
terminating the ability of additional users to accept offered terms after a predetermined time;
calculating a commission payable to one or more digital currency wallets associated with the one or more smart contract computer protocols;
retrieving data related to the offered and accepted terms of the one or more smart contract computer protocols;
determining values of digital currency owed to users based on the offered and accepted terms, retrieved data, and amounts of the previously authorized transmissions of digital currency; and
transmitting values of digital currency to digital currency wallets associated with users to which the values are owed.

10. The method of claim 9, wherein the offered terms are one of fixed odds, dynamic odds, live odds, in-event odds, odds that an event will happen, odds that an event will not happen, prices to buy odds that an event statistic will be true, prices to sell odds that an event statistic will be false, odds related to the finishing order of contestants in a contest, points related to the real-world performance of persons or groups of persons, odds related to the identity of the party to mine a particular block in a blockchain, and odds related to characteristics of a particular block in a blockchain.

11. The method of claim 9, wherein the acceptance of the one or more of the offered terms, and authorization of the one or more transmissions of digital currency, comprise a wager on the subject matter of the one or more smart contract computer protocols.

12. The method of claim 10, wherein the event is one or more of a sports event, a gambling event, a public contest, and a divisible micro-event thereof.

13. The method of claim 9, further comprising the data being retrieved, verified as accurate real-world data, and transmitted to the one or more smart contract computer protocols by one or more of one or more application programming interfaces, one or more data carriers, one or more proof-of-stake blockchain models, one or more proof-of-work blockchain models, one or more data aggregators, and one or more external oracle services.

14. The method of claim 9, wherein the data is one or more of fixed odds, dynamic odds, micro-event data, scores, statistics, point spreads, news, event outcome data, blockchain data, gambling data, and records.
